(19) United States
(12) Patent Application Publication
(10) Pub. No.: US 2016/0085334 A1
(43) Pub. Date: Mar. 24, 2016

(54) TOUCH-SENSING DEVICE

(71) Applicant: InnoLux Corporation, Miao-Li County (TW)

(72) Inventor: Kazuyuki HASHIMOTO, Miao-Li County (TW)

(21) Appl. No.: 14/493,439

(22) Filed: Sep. 23, 2014

(51) Int. Cl. G06F 3/044

(52) U.S. Cl. CPC G06F 3/044

(57) ABSTRACT

A touch-sensing device is provided. The touch-sensing device includes a central sensing pad and a plurality of first sensing pads. The central sensing pad consists of a single sensing pad. The first sensing pads are arranged along a first annular path surrounding the central sensing pad.

### BACKGROUND OF THE INVENTION

1. Field of the Invention

The invention relates to a touch-sensing device, and in particular to a touch-sensing device utilizing decreased receiver pads.

2. Description of the Related Art

Capacitive touch-sensing devices have been found to work particularly well in portable electronic devices. Generally speaking, whenever two electrically conductive members come close to one another without actually touching, their electric field interact to form capacitance. In the case of a capacitive touch device, as an object such as a finger approaches the touch-sensing surface, a tiny capacitance forms between the object and the sensing points in close proximity to the object. By detecting changes in capacitance at each of the sensing points and noting the position of the sensing points, the sensing circuit can recognize multiple objects and determine the location, pressure, direction speed and acceleration of the object as it is moved across the touch surface.

With reference to FIG. 1, utilizing the pad pattern of the conventional square touch-sensing device to the circular touch-sensing device 1, irregular pad portions 2 would formed on the edge of the circular touch-sensing device, and distortion of electric field and touch performance degradation are generated. The shapes of the irregular pad portions 2 are complex and special, and this variety of electrode shape causes a distortion of electric field and touch performance degradation. Although capacitive sensing devices have been found to work particularly well in portable electronic devices, improvements to form, feel and functionality are still desired.

### BRIEF SUMMARY OF THE INVENTION

A touch-sensing device is provided. The touch-sensing device includes a central sensing pad and a plurality of first sensing pads. The central sensing pad consists of a single sensing pad. The first sensing pads are arranged along a first annular path surrounding the central sensing pad.

In one embodiment, the central sensing pad is a central receiver pad, and the first sensing pads are transmitter pads.

In one embodiment, shapes and dimensions of the first sensing pads are the same.

In one embodiment, the touch-sensing device further comprises a plurality of second sensing pads, arranged along a second annular path surrounding the first sensing pads

In one embodiment, a number of first sensing pads is less than a number of second sensing pads and the central sensing pad.

In one embodiment, the central sensing pad is a central transmitter pad, the first sensing pads are receiver pads, and the second sensing pads are transmitter pads.

In one embodiment, a plurality of first gaps are arranged along the first annular path, each of the plurality of first gaps is formed between two of the first sensing pads, a plurality of second gaps are arranged along the second annular path, each of the plurality of second gaps is formed between two of the second sensing pads, and each first gap and each second gap are misaligned.

In one embodiment, the second sensing pads comprise two first transmitter pads and two second transmitter pads, wherein each first transmitter pad is located between the two second transmitter pads, wherein the first transmitter pads generate a first transmitter signal, and the second transmitter pads generate a second transmitter signal.

In one embodiment, shapes and dimensions of the first sensing pads are the same, and shapes and dimensions of the second sensing pads are the same.

In one embodiment, the central sensing pad, the first sensing pads and the second sensing pads are located on the same plane.

In the embodiments of the invention, the number of the first sensing pads (four receiver pads) is less than the number of the second sensing pads plus the central sensing pad (nine transmitter pads). In the embodiment of the invention, the number of the of the transmitter pads is greater than the number of the of the receiver pad. Comparing the conventional art, the number of the receiver pads is reduced, and the number of the inverting amplifiers connected with the receiver pad is reduced (in this case, the number of the inverting amplifiers connected with the receiver pads is four). Therefore, the embodiment of the invention reduces the dimension of the touch-sensing device without deteriorating its sensing precision.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows the pad pattern of the conventional square touch-sensing device utilized to the circular touch-sensing device;

FIG. 2A is a circuit diagram of a mutual capacitive sensing input device, in accordance with one embodiment of the invention;

FIG. 2B shows the operation of the circuit diagram of FIG. 2A;

FIG. 3A shows a touch-sensing device of an embodiment of the invention;

FIG. 3B is a modified example of the embodiment of FIG. 3A;

FIG. 4A shows a touch-sensing device of another embodiment of the invention;

FIG. 4B is a modified example of the embodiment of FIG. 4A;

FIG. 5A shows the touch-sensing device of the embodiment of FIG. 4A being touched;

FIG. 5B shows the coordinates designated by finger being analyzed;

FIGS. 6A and 6B shows touch-sensing devices of further another embodiment of the invention; and

FIG. 7 shows a touch-sensing display of an embodiment of the invention.

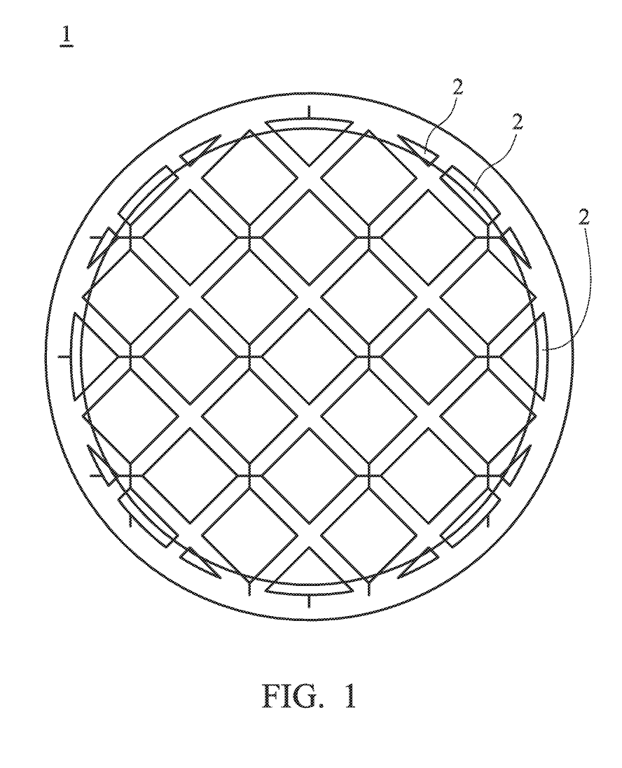

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

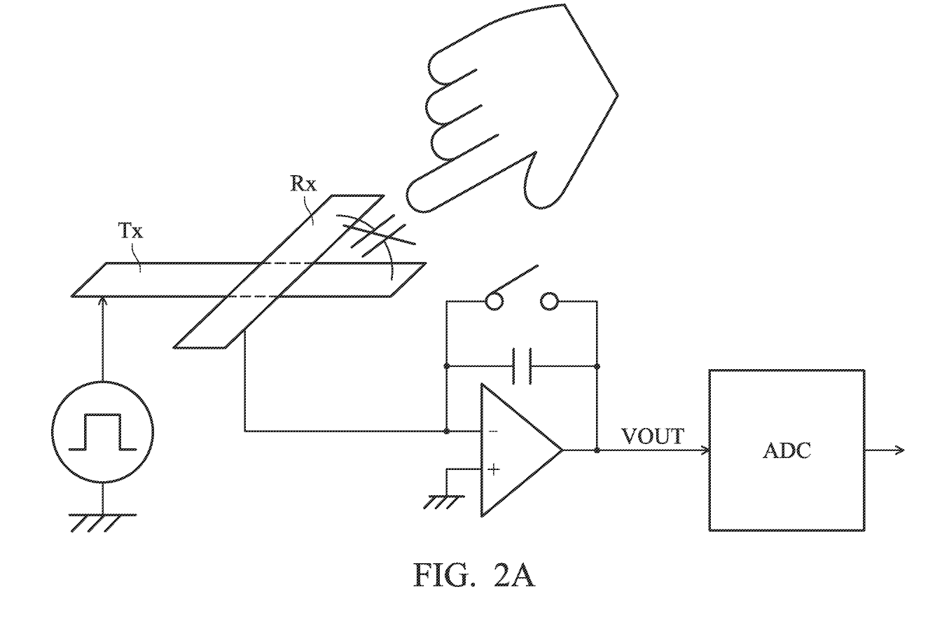

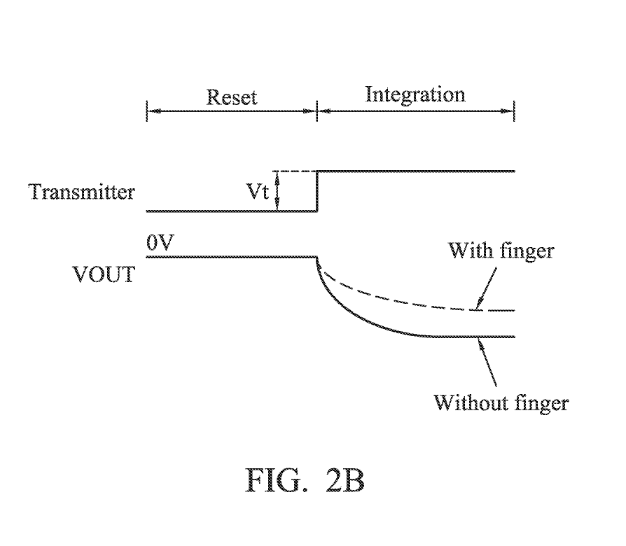

FIG. 2A is a circuit diagram of a mutual capacitive sensing input device, in accordance with one embodiment of the invention, and FIG. 2B shows the operation of the circuit diagram of FIG. 2A. With reference to FIGS. 2A and 2B, in the mutual capacitive sensing input device, control circuit for transmitter (Tx) consists of voltage source and switch to apply step input into Tx as scanning, one for receiver (Rx) consists of charge integrator with Op-Amp, capacitor and switch to convert a charge to voltage for analog digital converter (ADC). The charge transferred from Tx to Rx is proportional to capacitance coupling between them, the charge is influenced (reduced) by conductive object like finger as shield effect. Thus measuring voltage output of the charge integrator enables finger detection.

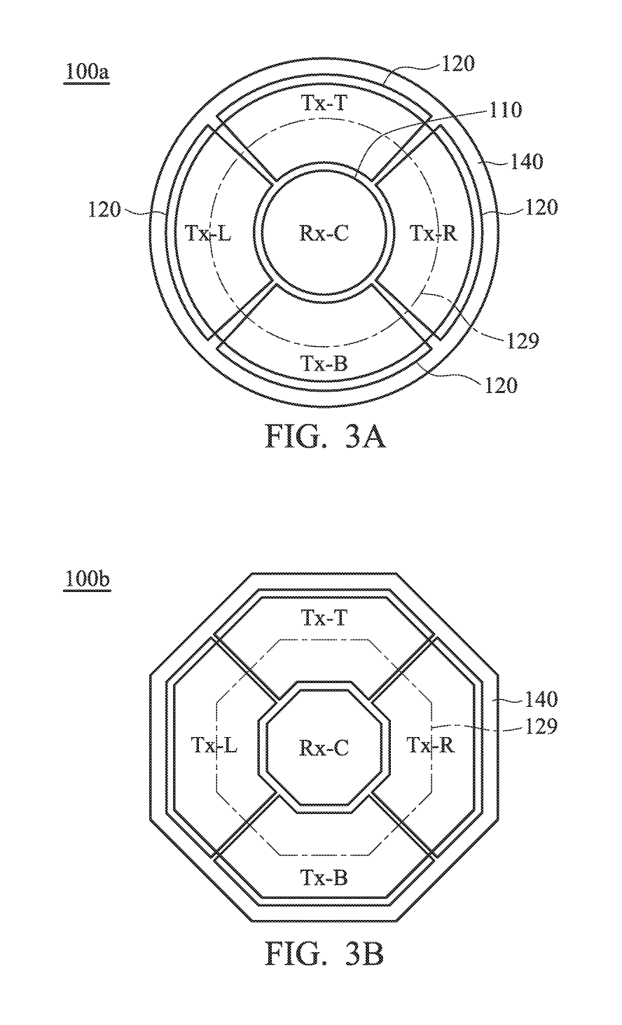

FIG. 3A shows a touch-sensing device 100a of an embodiment of the invention. The touch-sensing device 100a includes a central sensing pad Rx-C and a plurality of first sensing pads 120. The central sensing pad Rx-C consists of a single sensing pad. The first sensing pads 120 are arranged along a first annular path 129 surrounding the central sensing pad Rx-C. In this embodiment, the touch-sensing device 100a has a round shape. Specifically speaking, the touch-sensing device 100a includes a substrate 140 of round shape, and the central sensing pad Rx-C and the first sensing pads 120 are disposed on the round-shape substrate 140. However, according to the present invention, the shape of the touch-sensing device 100a is not limited and can be rectangular or non-rectangular. Non-rectangular shape includes hexagonal, octagonal, or polygonal, etc.

With reference to FIG. 3A, the central sensing pad Rx-C is a central receiver pad, and the first sensing pads 120 are transmitter pads. The first sensing pads 120 comprise a top transmitter pad Tx-T, a bottom transmitter pad Tx-B, a right transmitter pad Tx-R and a left transmitter pad Tx-L. The transmitter pads 120 have different time sequence signals to input scan signals. In one embodiment, shapes and dimensions of the first sensing pads 120 are the same.

With reference to FIG. 3A, in this embodiment, the first annular path 129 is circular, the central sensing pad 110 is circular, and the first sensing pads 120 are fan-shaped.

FIG. 3B shows a modified example of the invention, wherein the first annular path 129 is octagonal, and the central receiver pad 110 is octagonal. In this embodiment, the touch-sensing device 100b has an octagonal shape. Specifically speaking, the touch-sensing device 100b includes a substrate 140 of octagonal shape, and the central sensing pad Rx-C and the first sensing pads Tx are disposed on the octagonal-shape substrate 140.

With reference to FIG. 3B, the central sensing pad Rx-C is a central receiver pad, and the first sensing pads 120 are transmitter pads. The first sensing pads 120 comprise a top transmitter pad Tx-T, a bottom transmitter pad Tx-B, a right transmitter pad Tx-R and a left transmitter pad Tx-L. The transmitter pads 120 have different time sequence signals to input scan signals. In one embodiment, shapes and dimensions of the first sensing pads 120 are the same.

In the embodiments of FIGS. 3A and 3B, there is only one receiver pad working with four transmitter pads. In the conventional circular touch panel, the number of the receiver pads and the number of the transmitter pads are the same. In the embodiment of the invention, the number of the of the transmitter pads is greater than the number of the of the receiver pad. Comparing the conventional art, the number of the receiver pad is reduced, and the number of the inverting amplifiers connected with the receiver pad is reduced (in this case, there is one the inverting amplifier connected with the receiver pad). The number of the inverting amplifiers affects the dimension of the touch-sensing device. Therefore, the embodiment of the invention reduces the dimension of the touch-sensing device without deteriorating sensing precision. The embodiments of FIGS. 3A and 3B can be utilized in small devices, such as a smart watch.

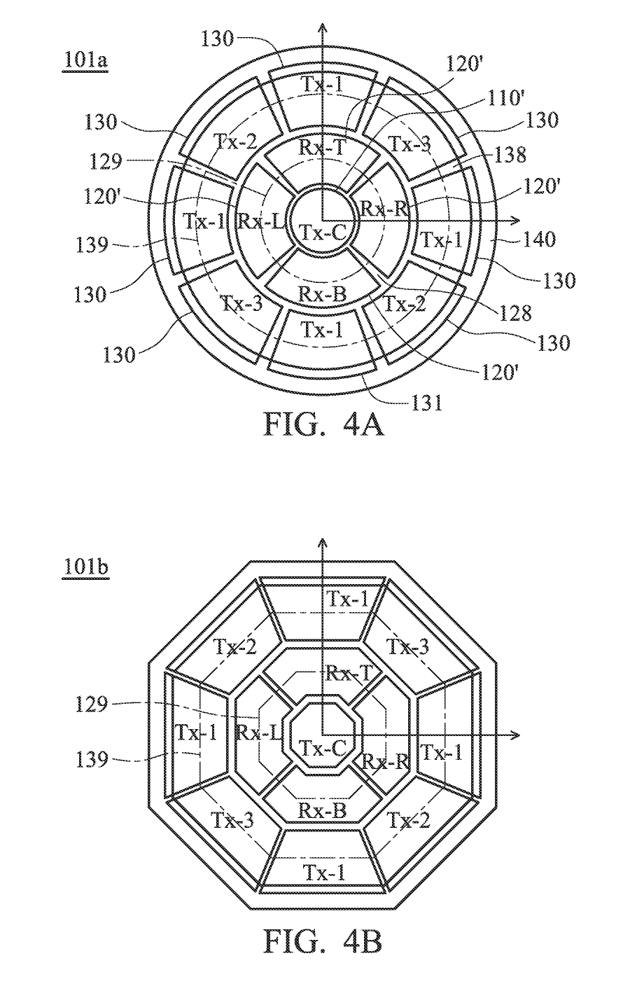

FIG. 4A shows a touch-sensing device 101a of an embodiment of the invention. The touch-sensing device 101a includes a central sensing pad Tx-C, a plurality of first sensing pads 120′ and a plurality of second sensing pads 130. The central sensing pad Tx-C consists of a single sensing pad. The first sensing pads 120′ are arranged along a first annular path 129 surrounding the central sensing pad Tx-C. The second sensing pads 130 arranged along a second annular path 139 surrounding the first sensing pads 120′, wherein there are fewer first sensing pads 120′ than second sensing pads 130 plus the central sensing pad Tx-C. In this embodiment, the touch-sensing device 101a has a round shape. Specifically speaking, the touch-sensing device 101a includes a substrate 140 of round shape, and the central sensing pad Tx-C and the first sensing pads 120′ are disposed on the round-shape substrate 140. However, according to the present invention, the shape of the touch-sensing device 101a is not limited and can be rectangular or non-rectangular. Non-rectangular shape includes hexagonal, octagonal, or polygonal, etc.

With reference to FIG. 4A, the central sensing pad Tx-C is a central transmitter pad, and the first sensing pads 120′ are receiver pads, and the second sensing pads 130 are transmitter pads. The transmitter pads 120 have different time sequence signals to input scan signals.

With reference to FIG. 4A, the first sensing pads 120′ comprise a top receiver pad Rx-T, a bottom receiver pad Rx-B, a right receiver pad Rx-R, and a left receiver pad Rx-L. The second sensing pads 130 comprise eight transmitter pads, which are four first transmitter pads Tx-1, two second transmitter pads Tx-2, and two third transmitter pads Tx-3, wherein each first transmitter pad Tx-4 is located between the second transmitter pad Tx-2 and the third transmitter pad Tx-3.

With reference to FIG. 4A, the central sensing pad Tx-C is a central transmitter pad, and the first sensing pads 120′ are receiver pads. The first sensing pads 120′ comprise a top receiver pad Rx-T, a bottom receiver pad Rx-B, a right receiver pad Rx-R and a left receiver pad Rx-L. The transmitter pads 120 have different time sequence signals to input scan signals. In one embodiment, shapes and dimensions of the first sensing pads 120′ are the same.

With reference to FIG. 4A, in one embodiment, the top receiver pad Rx-T, the bottom receiver pad Rx-B, the right receiver pad Rx-R and the left receiver pad Rx-L are respectively positioned at orientations of 0°, 90°, 180° and 270°, and the first transmitter pads are respectively positioned at orientations of 0°, 90°, 180° and 270°.

With reference to FIG. 4A, a plurality of first gaps 128 are arranged along the first annular path, each of the plurality of first gaps 128 is formed between two of the first sensing pads 120′, a plurality of second gaps 138 are arranged along the second annular path, each of the plurality of second gaps 138 is formed between two of the second sensing pads 130, and each first gap 128 and each second gap 138 are misaligned.

Therefore, the sensing resolution of the touch-sensing device can be improved. In this embodiment, shapes and dimensions of the first sensing pads 120′ are the same, and shapes and dimensions of the second sensing pads 130 are the same.

With reference to FIG. 4A, in this embodiment, the first annular path is circular, the central sensing pad is circular, the first sensing pads are fan-shaped, and the second sensing pads are fan-shaped. However, the invention is not limited thereto. For example, with reference to FIG. 4B, in this embodiment, the first annular path 129 of the touch-sensing device 101b is octagonal, the second annular path 139 is octagonal, and the central transmitter pad Tx-C is octagonal.

In one embodiment, the central sensing pad, the first sensing pads and the second sensing pads are located on the same plane.

In the embodiments of FIGS. 4A and 4B, the number of the first sensing pads (four receiver pads) is less than the number of the second sensing pads plus the central sensing pad (nine transmitter pads). In the embodiment of the invention, the number of the of the transmitter pads is greater than the number of the of the receiver pad. Comparing the conventional art, the number of the receiver pads is reduced, and the number of the inverting amplifiers connected with the receiver pad is reduced (in this case, the number of the inverting amplifiers connected with the receiver pads is four). Therefore, the embodiment of the invention reduces the dimension of the touch-sensing device without deteriorating its sensing precision.

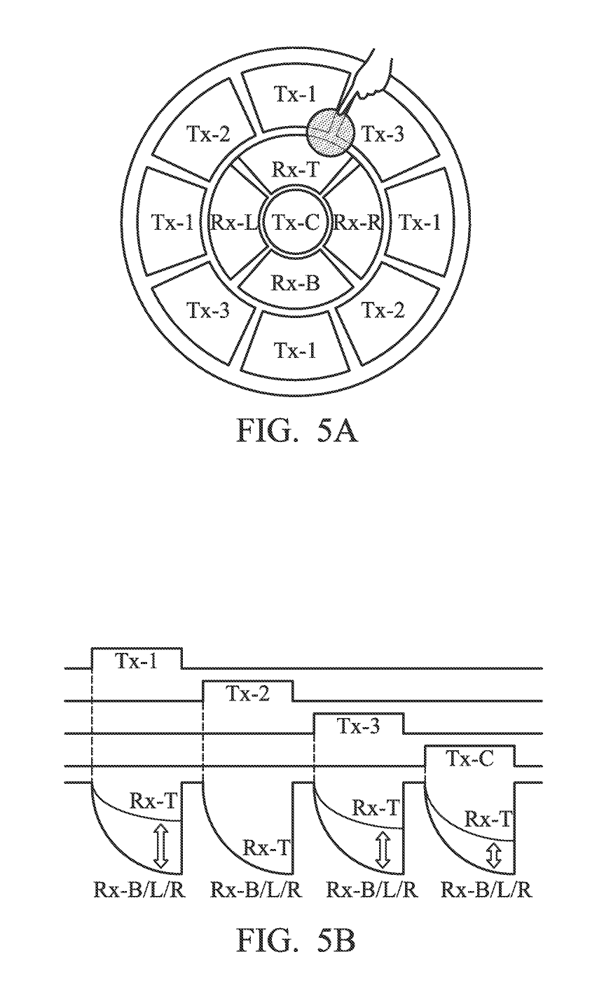

With reference to FIG. 5A, in the touch-sensing device of the embodiment of the invention, a voltage is applied on transmitter pads sequentially, and all receiver pads output are measured. When the touch-sensing device is touched, each output is analyzed to identify the coordinates designated by the finger. With reference to FIG. 5B, when an area A is touched, only the top receiver pad Rx-T has large offset voltages with the first transmitter pads Tx-1, the third transmitter pad Tx-3 and the central transmitter pad Tx-C inputs and no offset with the second transmitter pads Tx-2 input, and the coordinate designated by finger is identified.

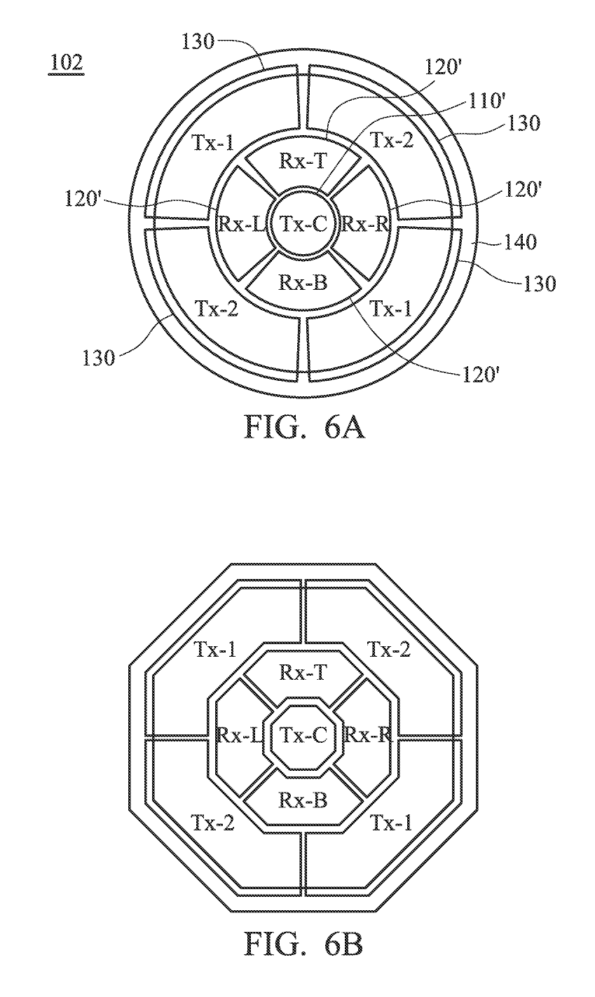

FIGS. 6A and 6B shows a touch-sensing device 102 of an embodiment of the invention. The touch-sensing device 102 is similar to the touch-sensing device 101. The touch-sensing device 102 is characteristic in that the second sensing pads 130 comprises two first transmitter pads Tx-1 and two second transmitter pads Tx-2. The embodiment of FIGS. 6A and 6B are appreciated for cost reduction of touch IC via reduction of number of transmitter signal.

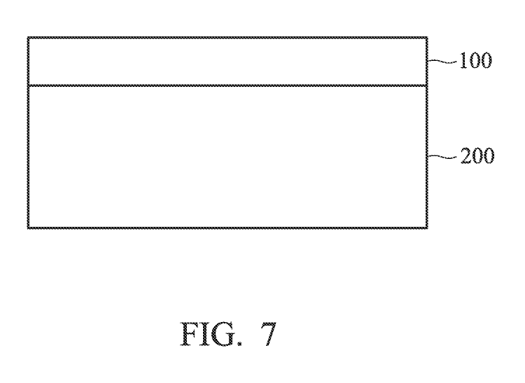

FIG. 7 shows a touch-sensing display of an embodiment of the invention, which comprises a display device 200 and the touch-sensing device mentioned above (such as the touch-sensing device 100). The touch-sensing device is disposed on the display device 200.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A touch-sensing device, comprising:
a central sensing pad, wherein the central sensing pad consists of a single sensing pad; and
a plurality of first sensing pads, arranged along a first annular path surrounding the central sensing pad,
wherein the central sensing pad and the first sensing pads comprise at least one receiver pad and a plurality of transmitter pads, and a number of the receiver pads is less than a number of the transmitter pads.

2. The touch-sensing device as claimed in claim 1, wherein the central sensing pad is a central receiver pad, and the first sensing pads are transmitter pads.

3. The touch-sensing device as claimed in claim 1, wherein shapes and dimensions of the first sensing pads are the same.

4. The touch-sensing device as claimed in claim 1, further comprising a plurality of second sensing pads, arranged along a second annular path surrounding the first sensing pads.

5. The touch-sensing device as claimed in claim 4, wherein a number of first sensing pads is less than a number of second sensing pads and the central sensing pad.

6. The touch-sensing device as claimed in claim 4, wherein the central sensing pad is a central transmitter pad, the first sensing pads are receiver pads, and the second sensing pads are transmitter pads.

7. The touch-sensing device as claimed in claim 4, wherein a plurality of first gaps are arranged along the first annular path, each of the plurality of first gaps is formed between two of the first sensing pads, a plurality of second gaps are arranged along the second annular path, each of the plurality of second gaps is formed between two of the second sensing pads, and each first gap and each second gap are misaligned.

8. The touch-sensing device as claimed in claim 7, wherein the second sensing pads comprise two first transmitter pads and two second transmitter pads, wherein each first transmitter pad is located between the two second transmitter pads, wherein the first transmitter pads generate a first transmitter signal, and the second transmitter pads generate a second transmitter signal, wherein the first transmitter signal is not equal to the second transmitter signal.

9. The touch-sensing device as claimed in claim 4, wherein shapes and dimensions of the first sensing pads are the same, and shapes and dimensions of the second sensing pads are the same.

10. The touch-sensing device as claimed in claim 4, wherein the central sensing pad, the first sensing pads and the second sensing pads are located on the same plane.

11. A touch-sensing display, comprising:
a display device; and
a touch-sensing device, disposed on the display device, comprising:
a central sensing pad;
a plurality of first sensing pads, arranged along a first annular path surrounding the central sensing pad, wherein the central sensing pad and the first sensing pads comprise at least one receiver pad and a plurality of transmitter pads, and a number of the receiver pads is less than a number of the transmitter pads.
